(19) United States
(12) Patent Application Publication
(10) Pub. No.: US 2012/0291595 A1
(43) Pub. Date: Nov. 22, 2012

(54) Multiple Interface Wrench and a Method

(76) Inventor: Timothy Raymond Hemesath, Liberty Hill, TX (US)

(21) Appl. No.: 13/441,859

(22) Filed: Apr. 7, 2012

Related U.S. Application Data
(60) Provisional application No. 61/516,767, filed on Apr. 7, 2011.

(51) Int. Cl. B25B 13/02; B25B 23/00

(52) U.S. Cl. 81/119; 173/1

(57) ABSTRACT

A wrench having multiple tool interfaces is provided. The wrench includes means for manually rotating about an axis located between the proximal and distal ends using a single force in a substantially tangential direction about the axis. The means for rotation might be a curve suitable for interface with a human finger. A method of rotating a tool is also provided.

### CROSS REFERENCE TO RELATED APPLICATIONS

This application claims priority to U.S. Provisional Application 61/516,767 filed on Apr. 7, 2011.

### STATEMENT REGARDING FEDERALLY SPONSORED RESEARCH OR DEVELOPMENT

Not Applicable

### REFERENCE TO SEQUENCE LISTING

Not Applicable

### BACKGROUND

In the course of manufacturing components in industry today, it is common to mill those components using a milling machine, or mill, possibly a CNC mill. A mill operator is present to set up parts to be produced on the mill. The set-up operation requires that the operator properly align material to be machined, called a blank, in the mill, as well as to attach a milling tool to a toolholder, which is then assembled to a spindle and/or tool changer. Multiple milling tools, each attached to a separate toolholder, may be used in a mill having a tool changer.

An operator generally uses many hand tools in the course of the set-up procedure. For example, in the course of manufacturing ion implanters using a CAT 40 compatible machine, an operator may use an ER32 spanner wrench to tighten a milling tool, such as an endmill, drill, or special tooling, directly in a short ER32 collet nut. A castle nut wrench or a hex head wrench might then be used to load and tighten an ER11 extension to the ER32 collet nut. In another case, a castle nut wrench or a 1″ wrench might be used to load and tighten an ER16 extension in the ER32 collet nut mentioned above. That is, an operator must have on hand a total of seven hand tools to be prepared to load machining tools for the milling of, for example, ion implanters.

The sheer number of tools required is inefficient, as the management of these tools hinders operator productivity, and the cost of so many tools is high.

There remains a need to reduce the number of tools required in the manufacture of ion implanters.

### SUMMARY

The present invention relates to a wrench having multiple tool interfaces. The present invention further relates to a method of using a tool having multiple tool interfaces.

### BRIEF DESCRIPTION OF THE DRAWINGS

FIG. 1 is a top view of an embodiment of the present invention.

FIG. 2 is a side view of the embodiment shown in FIG. 1.

FIG. 3 is a depiction of a standard wrench according to the prior art.

FIG. 4 is a detail view of the embodiment shown in FIG. 1.

### DESCRIPTION

The present invention relates to a wrench 10 having multiple tool interfaces.

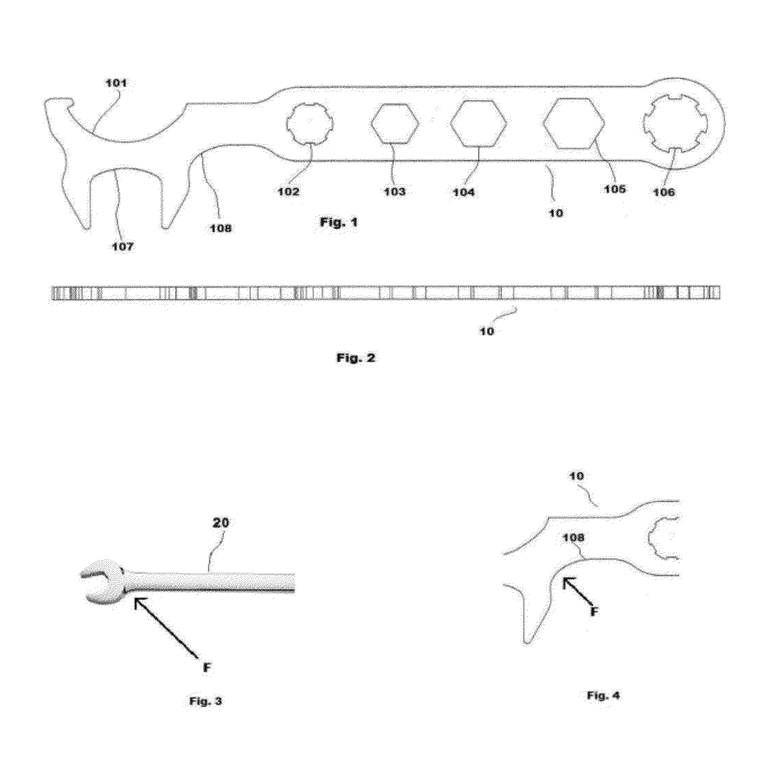

Referring now to FIG. 1, an embodiment of the wrench 10 of the present invention is shown. This embodiment comprises an ER32 spanner interface 101, an ER11 castle nut extension interface 102, an ER11 hex head collet extension interface 103, an ER11 collet nut interface 104, a 6″ kurt vise handle interface 105, an ER16 castle nut collet extension interface 106, and an ER16 1″ collet nut interface 107. The ER11 hex head collet extension interface 103 may also serve as an interface for a 4″ kurt vise handle. These interfaces may be used in lieu of the multiple tools described in the background of this application, and in the same manner.

The placement of the interfaces 101 through 107 on the wrench 10 is not random or arbitrary. Specifically, the larger interfaces are located near the ends of the wrench 10, while the smaller interfaces are located near the center. This placement improves the ergonomics for the operator, as well as optimizes the conformance to torque specifications.

Continuing with reference to FIG. 1, a curve 108 is placed near the ER16 1″ collet nut interface 107. This curve 108 provides a gripping and/or point of rotation location for the operator to rotate a tool. For example, ER11 hex head collet extension interface 103 may be interfaced with a kurt vise, and then the operator may open or close the vise by rotating the wrench 10 by applying a substantially tangential force with one finger at the curve 108. The operator may then apply a final tightening force while using a gripping force on the wrench 10. Using a single finger to rotate the wrench 10 not only increases the speed of operation but also reduces the space needed for the operator. It is noted here that when working at increased speeds, operators attempt to rotate tools by using a single finger. At the current time, this is met with limited success, as the tools currently available do not prevent the operator's finger from sliding off of the wrench. See, for example FIG. 3, which shows how a Force F applied using a single finger would lead to the operator's finger sliding off of the wrench 20 of the prior art. With the wrench 10 of the present invention, in contract, the curve 108 prevents the operator's finger from sliding off of the wrench 10, even when there is a slight radial component to the substantially tangential force applied by the finger. See FIG. 4, which shows how the Force F of an operator's finger would not lead to the finger slipping off of the wrench 10 of the present invention. It will be understood by those active in the industry that, although FIG. 4 demonstrates a Force F expected with a clockwise turn, the wrench 10 can be oriented in the opposite direction for a counter-clockwise turn. Generally, a slightly positively radial component will exist in the early and end stages of rotation of a vise grip, and a strictly tangential force will exist when the vise grip is approximately horizontal.

Referring now to FIG. 2, a side view of the wrench 10 of the present invention is shown. This side view demonstrates that the wrench 10 is generally flat in this embodiment. In a preferred embodiment, the wrench 10 is manufactured of 3/16″ or ¼″ material, possibly 4130 Chromalloy, heat treated and annealed.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A wrench having multiple tool interfaces, wherein said wrench comprises:
a proximal end and a distal end,
means for manually rotating said wrench about an axis located between said proximal and distal ends using a single force in a substantially tangential direction about said axis.

2. The wrench of claim 1, wherein said means for rotating comprises a curve, said curve suitable for interface with a human finger.

3. The wrench of claim 2, comprising
a first tool interface near said proximal end,
a second tool interface, and wherein
said curve is between said first and second tool interfaces.

4. The wrench of claim 3, wherein said first tool interface is an ER32 collet nut interface.

5. The wrench of claim 1, comprising an ER32 collet nut interface, a castle nut interface and a hex head interface.

6. The wrench of claim 1, wherein said force comprises a positively radial component.

7. The wrench of claim 2, wherein said curve comprises a varying radius.

8. The wrench of claim 2, wherein said curve comprises a 1 inch radius.

9. A method of rotating a tool about an axis, comprising the steps of:
providing a wrench having a first tool interface, a second tool interface, and a curve therebetween,
interfacing said wrench with said tool, and
rotating said wrench by applying a force to said curve, said force further being substantially tangential to said axis.

10. The method of claim 9, wherein said force is applied by a single finger.

11. The method of claim 9, wherein said force comprises a positively radial component.
